(19) United States
(12) Patent Application Publication
(10) Pub. No.: US 2025/0051617 A1
(43) Pub. Date: Feb. 13, 2025

(54) ULTRA-VIOLET CURABLE ACRYLIC PRESSURE SENSITIVE ADHESIVES

(71) Applicant: Henkel AG & Co. KGaA, Düsseldorf (DE)

(72) Inventors: Sonny Yuxia Liu, Bridgewater, NJ (US); Edwin C Kellam, III, Bridgewater, NJ (US)

(21) Appl. No.: 18/924,063

(22) Filed: Oct. 23, 2024

Related U.S. Application Data
(63) Continuation of application No. PCT/US2023/066100, filed on Apr. 24, 2023.

(30) Foreign Application Priority Data
Apr. 29, 2022 (US) 63363869

(51) Int. Cl. C09J 7/38

(52) U.S. Cl. CPC C09J 7/385; C09J 2301/302; C09J 2301/416

(57) ABSTRACT

An ultra-violet (UV) curable acrylic pressure sensitive adhesive (PSA) with high cohesive strength and high bio-content is described. The PSA has versatile cure profile and can be cured by conventional mercury bulbs or UV LED lamps and is particularly useful as a high-performance tape. In addition, the PSA is suitable for low temperature processing, particularly from room temperature to 120° C.

### FIELD OF THE INVENTION

An ultra-violet (UV) curable acrylic pressure sensitive adhesive (PSA) with high cohesive strength and high bio-content is described. The PSA has versatile cure profile and can be cured by conventional mercury bulb or UV LED lamp and is particularly useful as a high-performance tape. In addition, the PSA is suitable for low temperature processing, particularly from room temperature to 120° C.

### BACKGROUND OF THE INVENTION

Pressure sensitive adhesives (PSAs) are aggressive and permanently tacky at room temperature and adhere to surfaces by application of light finger pressure. PSA compositions are commonly applied to various substrates, such as paper, fabric, metal, and plastic films that are then converted into many different products, especially pressure sensitive adhesive tapes and labels. These pressure sensitive adhesive products have a broad field of application in many industries including automobile industry for fastening or sealing, pharmaceutical industry for bandages or transdermal drug delivery systems, in packaging industry for sealing, bonding, or labeling, and the like. PSAs can be formulated for application as a solution or a melt adhesive.

Hot melt pressure sensitive adhesives (HMPSAs) are compositions that combine the properties of hot melt adhesives with those of pressure sensitive adhesives. Hot melt adhesives are solids or semi-solid at room temperature, melt at elevated temperatures to coat on a substrate, and regain their solid form on cooling. The combination of these properties provides compositions that melt at elevated temperatures and cool to form a permanently tacky solid coating that adheres on contact. A good workable HMPSA must exhibit high cohesive strength at room temperature, low shrinkage on substrates, retention of pressure sensitive properties during storage and use, and a relatively fluid viscosity at typical coating temperatures (e.g., between 80° C. and 180° C.). Although very low molecular weight polymers will yield hot melt adhesives with sufficient fluidity, the resulting adhesives lack cohesive strength. Very high molecular weight polymers give better cohesive strength but are too viscous at the common application temperatures to be easily coated on substrates. They must be blended with a high proportion of low molecular weight oils or resins to reduce the viscosity. The addition of low molecular weight oils or resins in turn detracts from the cohesive strength and heat resistance. To avoid these problems, polymers of moderate molecular weight have been made with various functional groups which undergo crosslinking reactions by heat or actinic radiation. In this manner, the cohesion of acrylic PSAs can be raised by means of sufficient crosslinking. Acrylic polymers with epoxy functional groups have been known in prior art. An example of such polymers is described in JP1186876, however, these polymers fail to crosslink under UV radiation and/or heat.

JP2008-208149 is directed to acrylic copolymers with non-polymerizable oxetane compounds as a polymerization medium and reactive diluent. Polymerization is achieved with heat and/or x-ray irradiation to form an adhesive for a flat panel display.

JP19940816 and 1996060127 describe UV-curable acrylic polymers but requires the addition of multifunctional polyol and other hydroxy-functional groups for crosslinking the polymers.

JP2003147311 is directed to the use of photopolymerizable diacrylate. Due to the difunctional acrylate, it is less desirable for use in an adhesive because it becomes partially crosslinked before application onto substrates.

U.S. Pat. Nos. 8,796,350 and 9,469,794 describe UV curable pressure sensitive adhesives that are coatable in the higher ranges of 80-180° C., which may be unsuitable for heat-sensitive substrates and/or decrease the pot life of the adhesives.

There is an ongoing demand and a continuing need in the art for UV-curable acrylic adhesives that are hot melt processable adhesives at a low temperature range from room temperature to 120° C., and curable with UV LED lamps from 365 nm to 405 nm. In addition, a large demand exists for greener and more sustainable adhesives. The current invention addresses these needs by decreasing processability temperature and increasing bio-content.

### SUMMARY OF THE INVENTION

An ultra-violet (UV) curable acrylic pressure sensitive adhesive (PSA) with high cohesive strength and high bio-content for high performance tape is described.

In one embodiment, the UV curable pressure sensitive adhesive comprises an acrylic polymer prepared from at least one acrylic monomer having a reactive functional group selected from the group consisting of cycloaliphatic epoxide, vinyl ether, oxirane, oxetane, and mixtures thereof; a reactive diluent that is essentially free of mono- or multi-(meth)acrylate; and a cationic photoinitiator.

In another embodiment, the UV curable pressure sensitive adhesive comprises:
A. 10-95% wt of an acrylic polymer having at least one terminal or pendant reactive functional group selected from the group consisting of cycloaliphatic epoxide, vinyl ether, oxirane, oxetane, and mixtures thereof;
B. 4-90 wt % of a reactive diluent, which is essentially free of mono- or multi-(meth)acrylate; and
C. 0.01 to 5 wt % of a cationic photoinitiator.

The total weight of the UV curable pressure sensitive adhesive is 100 wt %.

In yet another embodiment, the UV curable pressure sensitive adhesive comprises:
A. 10-95% wt of an acrylic polymer having at least one terminal or pendant reactive functional group selected from the group consisting of cycloaliphatic epoxide, vinyl ether, oxirane, oxetane, and mixtures thereof;
B. 4-90% wt of a reactive diluent selected from the group consisting of an epoxy functionalized soybean oil, epoxy functionalized polybutadiene, epoxy-functional polyurethane, epoxy functionalized polysiloxane, epoxy functionalized polyisobutylene, epoxy-difunctionalized bisphenol A epoxy resin, epoxy-difunctionalized bisphenol F epoxy resin, epoxy functionalized polyacrylate, epoxy functionalized polyethylene glycol, epoxy functionalized polypropylene glycol, epoxy functionalized polyether, and mixtures thereof, and wherein the reactive diluent is essentially free of mono- or multi-(meth)acrylate; and
C. 0.01 to 5 wt % of a cationic photoinitiator.

Another embodiment of the invention is directed to an article of manufacture comprising a substrate and an UV curable pressure sensitive adhesive, wherein the UV curable pressure sensitive adhesive comprises:
A. 10-95% wt of an acrylic polymer having at least one terminal or pendant reactive functional group selected from the group consisting of cycloaliphatic epoxide, vinyl ether, oxirane, oxetane, and mixtures thereof;
B. 4-90% wt of a reactive diluent, which is essentially free of mono- or multi-(meth)acrylate; and
C. 0.01 to 5 wt % of a cationic photoinitiator.

In another embodiment, the invention is directed to a UV curable pressure sensitive adhesive having a matrix of (A) an acrylic polymer having reactive terminal or pendant functional groups, selected from cycloaliphatic epoxide, vinyl ether, oxirane, oxetane or mixtures thereof, bound to the acrylic polymer backbone; (B) a reactive diluent having a terminal or pendant reactive functional group selected from cycloaliphatic epoxide, oxirane, oxetane, vinyl ether, or mixtures thereof; and (C) a cationic photoinitiator. The matrix is essentially free of mono- or multi (meth)acrylate groups. The reactive functional groups of the acrylic polymer (A) and the terminal or pendant functional groups of the reactive diluent (B) undergo a UV cure to form a pressure sensitive adhesive in the presence of cationic photoinitiator (C).

### DETAILED DESCRIPTION OF THE INVENTION

All documents cited herein are incorporated in their entireties by reference.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

As used in the specification and in the claims, the term “comprising” may include the embodiments “consisting of and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of and “consisting essentially of the enumerated ingredients/steps, which allows the presence of only the named ingredients/steps, along with any impurities that might result therefrom, and excludes other ingredients/steps.

Numerical values in the specification and claims of this application, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values. As used herein, approximating language may be applied to modify any quantitative representation that may vary without resulting in a change in the basic function to which it is related. Accordingly, a value modified by a term or terms, such as “about,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11 “, and “about 1” may mean from 0.9-1.1. Other meanings of “about” may be apparent from the context, such as rounding off, so, for example “about 1” may also mean from 0.5 to 1.4.

As used herein, a polymer or an oligomer is a macromolecule that consists of monomer units is equal or greater than about 2 monomer units. Polymer and oligomer are used interchangeably here in the invention.

As used herein, the terms “pressure sensitive adhesive” or “PSA,” used interchangeably, refer to a viscoelastic material which adheres instantaneously to most substrates with an application of slight pressure and remains permanently tacky.

As used in herein, the term, “essentially free” means that the composition has less than 1% by weight, preferably less than 0.1% by weight, and most preferably, may not include more than trace amounts of the named component.

As used in herein, the term, “no additional added component” means that the named component is purposefully not added, while trace amounts may be present.

The invention is directed to an ultra-violet (UV) curable pressure sensitive adhesive comprising (A) an acrylic polymer having cationic-reactive terminal or pendant functional groups bound to the acrylic polymer backbone; (B) a reactive diluent having a terminal or pendant functional group selected from cycloaliphatic epoxide, oxirane, oxetane, vinyl ether, or mixtures thereof; and (C) a cationic photoinitiator. The acrylic polymer (A) having cationic-reactive terminal or pendant functional groups bound to the acrylic polymer backbone and the terminal or pendant functional group of the reactive diluent (B) undergo fast cationic crosslinking reaction under the catalysis of a super acid generated by the decomposition of the cationic photoinitiator under UV irradiation. The initial fast crosslinking provides green strength to the adhesive, and a post-UV crosslinking that continues over a couple of minutes and up to a few days provides high cohesive strength and high adhesion performance over wide range of application temperatures.

The acrylic polymer is prepared from:
(i) a first monomer having a reactive functional group selected from cycloaliphatic epoxide, vinyl ether, oxirane, oxetane or mixtures thereof; and
(ii) an acrylic monomer consisting of an acrylic or methacrylic acid derivative of the formula CH₂═CH(R₁)(COOR₂), wherein R₁ is H or CH₃ and R₂ is C₁₋₂₄ alkyl chain.

The amount of the first monomer (i) is from about 0.001 to about 10 g per 100 g of the acrylic polymer. In a more preferred embodiment, the amount of the first monomer (i) is from about 0.01 to about 5 g per 100 g of the acrylic polymer.

Suitable first monomer (i) of the polymer is capable of undergoing UV-activated cationic crosslinking reaction and providing green strength to the adhesive and includes vinyl or acrylic compounds containing cationic UV-reactive functional groups with the formula (1):

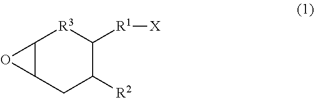

where
R¹ is O, S, C═O, or linear, branched, or cyclic alkylene, or oxyalkylene, arylene,
R² is linear, branched, and cyclic alkyl or alkoxy, aryl, H, halogen, C═O, or part of R¹ as fused cycloaliphatic ring through a covalent bond connection,
R³ is (CH₂) n, n=0-3,
X is acrylate, methacrylate or comprises a —W—Y group,
W is O, S, amide, carbonate, urethane, urea, siloxane, or a combination thereof, and
Y is —R⁴—C(R⁵)═CH₂, where R⁴ is a linear or branched C₂₋₁₀ alkylene or C₂₋₁₀oxyalkylene, or arylene or derivatives thereof, and R⁵ is H or CH₃.

One suitable first monomer (i) is represented by the structural formula (1A):

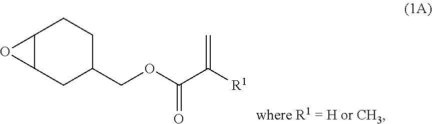

A preferred vinyl or acrylic compound for use as the first monomer (i) is represented by the structural formula (1B):

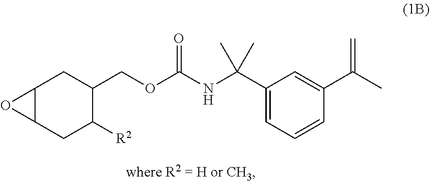

Another preferred vinyl or acrylic compound for use as the first monomer (i) is represented by the structural formula (1C):

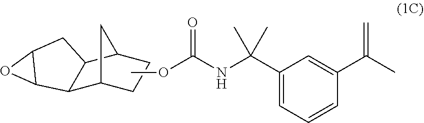

Another preferred vinyl or acrylic compound for use as first monomer (i) is represented by the structural formula (1D):

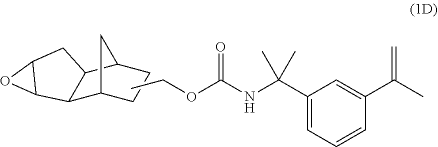

Yet another preferred vinyl or acrylic compound for use as first monomer (i) is represented by the structural formula (1E):

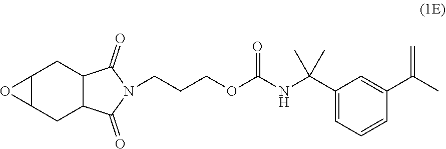 [SMILES: C=C(C)c1cccc(C(C)(C)NC(=O)OCCCN2C(=O)C3CC4OC4CC3C2=O)c1]

Yet another preferred vinyl or acrylic compound for use as first monomer (i) is represented by the structural formula (1F):

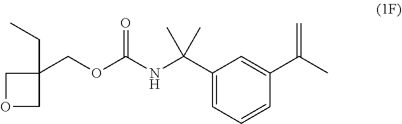 [SMILES: C=C(C)c1cccc(C(C)(C)NC(=O)OCC2(CC)COC2)c1]

Yet another preferred vinyl or acrylic compound for use as first monomer (i) is represented by the structural formula (1G):

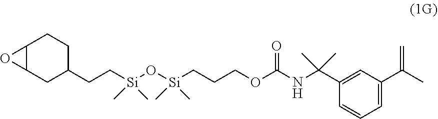 [SMILES: C=C(C)c1cccc(C(C)(C)NC(=O)OCCC[Si](C)(C)O[Si](C)(C)CCC2CCC3OC3C2)c1]

Yet another preferred vinyl or acrylic compound for use as first monomer (i) is represented by the structural formula (1H):

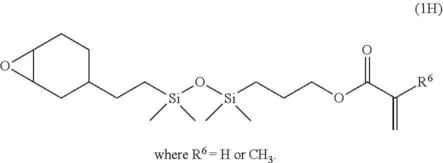

Yet another preferred vinyl or acrylic compound for use as first monomer (i) is represented by the structural formula (11):

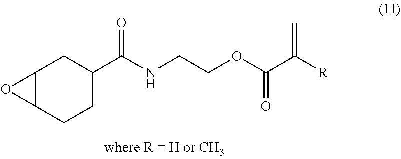

In another embodiment, the first monomer (i) is a vinyl or acrylic compound capable of undergoing either a fast UV activated cationic crosslinking reaction or a slow post UV crosslinking reaction, and thus providing the adhesive with high performance adhesion strength. These exemplary monomers include glycidyl methacrylate (GMA), 4-hydroxybutylacrylate glycidyl ether (4-HBAGE), cycloaliphatic epoxide monomer M100 and A400 (Daicel), OXE-10 (Kowa), UVIVURE S105 and S170, CD535 (Sartomer), 4-vinyl-1-cyclohexene-1,2-epoxide (DOW). Another example of suitable reactive functional groups has the following formula (2A):

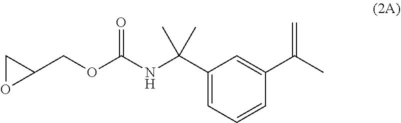 [SMILES: C=C(C)c1cccc(C(C)(C)NC(=O)OCC2CO2)c1]

The acrylic monomer (ii) consists of one monomer or a mixture of monomers from acrylic or methacrylic acid derivative of the formula CH₂═CH(R₁)(COOR₂), wherein R₁ is H or CH₃ and R₂ is C₁₋₂₄ alkyl. Examples of the acrylic monomer (ii) include methyl acrylate, ethyl acrylate, ethyl methacrylate, methyl methacrylate, n-butyl acrylate, n-butyl methacrylate, n-pentyl acrylate, n-hexyl acrylate, n-heptyl acrylate, and n-octyl acrylate, n-nonyl acrylate, lauryl methacrylate, cyclohexyl acrylate, branched (meth)acrylic isomers, such as i-butyl acrylate, i-butyl methacrylate, n-butyl methacrylate, 2-ethylhexyl acrylate, stearyl methacrylate, and isooctyl acrylate, or a mixture thereof. Exemplary acrylic monomer (ii) is a mono-functional acrylate and does not include any di- or multi-acrylate monomers.

The choice and relative amount of the specific acrylic and vinyl monomers making up the acrylic polymers used in preparing the adhesives of this invention depend upon the desired final properties and contemplated end uses of the adhesives. The choices of which acrylic and vinyl monomer or monomers and their relative amount in the final composition to achieve the desired properties are within the expertise of those skilled in the art.

The UV curable pressure sensitive adhesive wherein the acrylic polymer has a Tg value less than 0° C. and a weight average molecular weight (Mw) from about 1,000 to about 3,000,000 g/mol. In order to achieve a high cohesive strength and high performance of the UV curable adhesive, higher molecular weight acrylic polymers are desirable. The preferred weight average molecular weight (Mw) of the acrylic polymers is from about 50,000 to about 2,000,000 g/mol, even more preferably from about 200,000 to about 1,000,000 g/mol. For a room temperature coatable UV curable pressure sensitive adhesive, the preferred weight average molecular weight (Mw) of the acrylic polymers is from about 5,000 to about 500,000 g/mol, even more preferably from about 10,000 to about 100,000 g/mol.

For the polymerization process, the first monomer (i) and the acrylic monomer (ii) are converted by radical polymerization into acrylic polymers. In the polymerization, the monomers are chosen such that the resulting polymers can be used to prepare adhesives, especially such that the resulting polymers possess pressure sensitive adhesive properties in accordance with the “Handbook of Pressure Sensitive Adhesive Technology” by Donatas Satas (van Nostrand, N.Y. 1989). For these applications, the glass transition temperature of the resulting polymers will advantageously be below about 0° C.

The acrylic polymer is essentially free of multi-(meth)acrylate, polyol or OH-functional groups and the polymer remains essentially linear after polymerization.

The reactive diluent of the UV curable pressure sensitive adhesive is a polymer, oligomer or macromer comprising at least one terminal or pendant functional group selected from cycloaliphatic epoxide, oxirane, oxetane, vinyl ether, or mixtures thereof. The reactive diluent is essentially free of any mono- or multi-(meth)acrylates. The reactive diluent has a weight average molecular weight from about 100 to about 500,000 g/mol. In addition, the reactive diluent is preferably an epoxy functionalized soybean oil, epoxy functionalized polybutadiene, epoxy-functional polyurethane, epoxy functionalized polysiloxane, epoxy functionalized polybutadiene, epoxy functionalized polyisobutylene, epoxy-difunctionalized bisphenol A epoxy resin, epoxy-difunctionalized bisphenol F epoxy resin, epoxy functionalized polyacrylate, epoxy functionalized polyethylene glycol, epoxy functionalized polypropylene glycol, epoxy functionalized polyether or mixtures thereof.

In a preferred embodiment, the reactive diluent is bio-based or made from a bio-source. Bio-based or bio-sourced reactive diluent can be produced by reactions of renewable precursors such as vegetable oils, saccharides, tannins cardanols, terpenes, rosins, and lignins. The reactive diluent can range from about 4 to about 90 wt %, based on the total weight of the acrylic polymer. One primary function of a diluent is to reduce and control the viscosity of the adhesive and so it can be coated at low temperature. Low adhesive viscosity and low coating temperature is always preferred for thermal stability of the adhesive, heat sensitive substrates, and LED cure and low energy consumption of coating process. However, non-reactive diluents typically compromise the cohesive strength of the adhesive. In order to achieve a high cohesive strength and high performance of the UV-curable adhesive, normally a higher molecular weight and high viscosity acrylic polymers are used. The reactive diluent in the composition reduces the viscosity down to coatable range of about 1,000 to about 90,000 cps between 25 to 120° C., and more importantly, does not deteriorate the cohesive strength of the adhesive after UV cure. The reactive diluent participates in the cationic crosslinking reaction and thus, increases crosslinking density to enhance the adhesive's cohesive strength. The reactive diluent, however, must be balanced with a controlled amount of epoxy functionality between the acrylic polymer and the reactive diluent in order to avoid over-crosslinking and leading to adhesive films with low peel, low tack, and poor wettability. The reactive diluent can be a polymer, oligomer or macromer comprising at least one terminal or pendant functional group selected from cycloaliphatic epoxide, oxirane, oxetane, vinyl ether, or mixtures thereof. The preferred reactive diluent has a weight average molecular weight from about 100 to about 100,000 g/mol. The reactive diluent is preferably epoxy functionalized polybutadiene, epoxy-functional polyurethane, epoxy functionalized polysiloxane, epoxy functionalized polyisobutylene, epoxy-difunctionalized bisphenol A epoxy resin, epoxy-difunctionalized bisphenol F epoxy resin, epoxy functionalized polyacrylate, epoxy functionalized polyethylene glycol, epoxy functionalized polypropylene glycol, epoxy functionalized polyether, or mixtures thereof. Examples of commercially available reactive diluents include CELLOXIDE 2021P, CELLOXIDE 8000, CELLOXIDE 2081, EHPE 3150, EPOLEAD GT401, EPOLEAD PB Series, EPOFRIEND Series, UNICURE S128, UNICURE S150, UNICURE S160, EPON 828, EPON 862, KF-8100, KF-8145, KF-12102, KEW-L2000, KET-L3000, and DER 330. The reactive diluent can range from about 4 to about 90 wt %, based on the total weight of the UV curable adhesive.

One particular embodiment of the reactive diluent is bio-based or made from a bio-source. Bio-based or bio-sourced reactive diluent can be produced by reactions of renewable precursors such as vegetable oils, saccharides, tannins cardanols, terpenes, rosins, and lignins. Examples of bio-based reactive diluent include vikoflex-7170 and epoxidized soybean oil NATUREFLEXX ESO. These diluents are compatible with the acrylic polymer of the invention, and also slow the post-UV cure process with longer shadow cure and improve the wettability of the adhesive to substrates. Such wettability and bonding improvement enhance the adhesive strength over wide range of application temperatures, with a SAFT value of up to 200° C.

The matrix of the UV curable pressure sensitive adhesive comprises (A) an acrylic polymer having reactive terminal or pendant functional groups, selected from cycloaliphatic epoxide, vinyl ether, oxirane, oxetane or mixtures thereof, bound to the acrylic polymer backbone and (B) a reactive diluent having a terminal or pendant reactive functional group selected from cycloaliphatic epoxide, oxirane, oxetane, vinyl ether, or mixtures thereof. The reactive functional groups of both the polymer and the reactive diluent undergo UV crosslinking reaction in the presence of the cationic photoinitiator (C) to form a crosslinked network having high cohesive strength over a wide range of application temperatures.

The UV curable pressure sensitive adhesive further comprises a cationic photoinitiator. The primary function of the cationic photoinitiator is to initiate crosslinking reaction among the acrylic polymer (A) and the reactive diluent (B) when irradiated by UV light. The mechanism of a cationic photoinitiator, when UV irradiated, forms an excited state which then breaks down to release a cation radical. This cation radical reacts with the solvent, moisture, or other hydrogen atom donors, and generates a protonic acid, which is the active species that initiates the crosslinking reaction of the acrylic polymer (A) and the reactive diluent (B). The radical reactive functional groups such as (meth)acrylic C═C react with cation radical decomposed from the cationic photoinitiator upon UV irradiation. Such reaction hinders the formation of the superacid. Preferably, the adhesive composition of invention is essentially free of any radical reactive functional groups such as mono- or multi-(meth)acrylate to avoid competition and interference between radical cure and cationic cure during UV irradiation.

A number of cationic photoinitiators may be used to crosslink the acrylic polymer (A) and the reactive diluent (B) of this invention, including iodonium and sulfonium salts. These include, for example, diaryliodonium salts, triarylsulfonium salts, dialkylphenylsulfonium salts, dialkyl(hydroxydialkylphenyl)sulfonium salts and ferrocenium salts. The anions in theses salts generally possess low nucleophilic character and include SbF₆⁻, PF₆⁻, AsF₆⁻, BF₄⁻, B(C₆F₅)₄⁻ or Ga(C₆F₅)₄⁻, PFₙ(Rf)₆₋ₙ⁻. Specific examples include Omnicat 320, SPEEDCURE 937, SPEEDCURE 938, SPEEDCURE 939CPI-310B, CPI-200K, CPI-210S, and IK-1. Particularly useful cationic photoinitiators are soluble and LED reactive sulfonium salt photoinitiators having the structural formula (6A) and (7A):

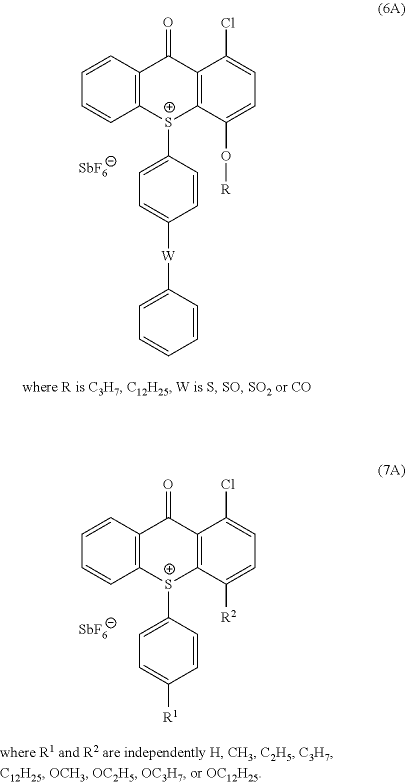

These cationic photoinitiators have a good solubility in the UV curable pressure sensitive adhesive of the invention, and promote efficient thick film UV curing, and exhibit thermal stability before cure, exhibit increased curing rates, and have a reduced dark cure time,

In a further embodiment, the cationic photoinitiator of the UV curable pressure sensitive adhesive has the structure of

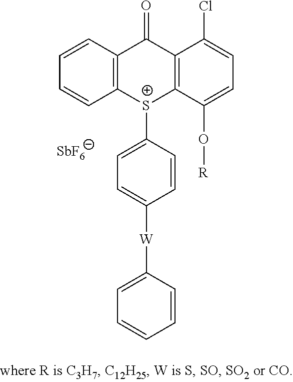

A photosensitizer can be used in addition to a cationic photoinitiator to enhance crosslinking efficiency, particularly when LED light sources in UVA range of from 365 nm to 405 nm, are used to cure the adhesive which contains conventional UVB and UVC cationic photoinitiators. Examples of photosensitizers include thioxanthen-9-one, 2-Isopropylthioxanthone (ITX), 2-chlorothioxanthen-9-one, 2,4-diethyl-thioxanthen-9-one (DETX), 1-chloro-4-propoxythioxanthone (CPTX), anthroquinone, phenanthrenequinone, camphorquinone, and the like.

In one embodiment, the UV curable pressure sensitive adhesive comprises:
A. 10-95% wt of the acrylic polymer having at least one terminal or pendant reactive functional group selected from the group consisting of cycloaliphatic epoxide, vinyl ether, oxirane, oxetane, and mixtures thereof;
B. 4-90% wt of the reactive diluent, which is essentially free of mono- or multi-(meth)acrylate; and
C. 0.01 to 5 wt % of the cationic photoinitiator.

The total weight of the UV curable pressure sensitive adhesive is 100 wt %.

The UV curable pressure sensitive adhesive, optionally, further comprises tackifier, plasticizer, thermal stabilizer, antioxidant, moisture scavenger, desiccant, and/or solvent.

The UV curable pressure sensitive adhesive optionally comprises a tackifier, from about 10-50% of adhesive, which are conventionally used in the preparation of PSAs. Explicit reference may be made to the depiction of the state of the art in the “Handbook of Pressure Sensitive Adhesive Technology” by Donatas Satas (van Nostrand, 1989) or any PSA related literatures. In general, it is possible to use any natural resins which are compatible with the corresponding acrylic polymers; reference may be made in particular to all natural resins. Non-limiting examples include pinene resins, indene resins, rosins, terpene resins, terpene-phenolic resins, gum rosin, wood rosin, tall-oil rosin, distilled rosin, hydrogenated rosin, dimerized rosin, polymerized rosin; and their disproportionated, and esterified derivatives and salts.

Other suitable tackifiers include aliphatic and aromatic hydrocarbon resins, hydrogenated hydrocarbon resins, and functional hydrocarbon resins. Non-limiting examples include aliphatic and aromatic hydrocarbon resins, C₅ resins, C₉ resins, and other hydrocarbon resins. Any desired combinations of these resins may be used in order to adjust the properties of the resultant PSA in accordance with the desired final properties.

Specific examples of these tackifiers include TECKROS R86, SYLVALITE RE 85 GB, FORAL 85-E, WINGTACK 95, CLEARTACK W85. One preferred embodiment of the tackier is liquid tackifiers, which may further reduce the viscosity of the adhesives. Examples include polymerized C5 petroleum feed stream and polyterpenes such as WINGTACK 10, and ESCOREZ 2520, liquid rosin ester tackifier SYLVALITE 2038.

The UV curable pressure sensitive adhesive optionally comprises a thermal stabilizer or antioxidant. Among the applicable stabilizers or antioxidants utilized herein include high molecular weight hindered phenols and multifunctional phenols such as sulfur and phosphorous containing phenols. Hindered phenols are well known to those skilled in the art and may be characterized as phenolic compounds which also contain sterically bulky radicals in close proximity to the phenolic hydroxyl group hereof. Any known thermal stabilizer may be suitable, and preferred classes of thermal stabilizers include, but are not limited to, phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), hydroxylamines, nitrones, thiosynergists, benzofuranones, indolinones, and mixtures thereof. Examples of commercially available stabilizers include IRGANOX 1010, IRGANOX 1520/1726, IRGANOX 565, IRGANOX 3114, IRGASTAB FS301, TINUVIN 123, TINUVIN 292, TINUVIN 5100, TINUVIN 249, TINUVIN 770, BHT, 4-MEHQ. Use of a thermal stabilizer is optional and, in some instances, not preferred. When a thermal stabilizer is used, it may be present at a level of about 0.001 g and up to about 0.5 g by weight, based on the total 100 g by weight of the adhesive.

The UV curable pressure sensitive adhesive optionally comprises a moisture scavenger. Examples of the moisture scavenger include vinyltrimethoxysilane, vinylmethyldimethoxysilane, hexamethyldisilazane, methyltriethoxysilane, (3-glycidyloxypropyl) trimethoxysilane, 3-(methacryloyloxy) propyl trimethoxysilane, 3-vinylpropyltriethoxysilane, oxime silanes or benzamidosilanes such as bis(N-methylbenzamido)methylethoxysilane or carbamatosilanes such as carbamatomethyltrimethoxysilane; or combination thereof. Vinyltrimethoxysilane and tetraethoxysilane are particularly preferred in terms of cost and efficiency. When a moisture scavenger is used, it may be present at a level of about 0.001% and up to about 0.5% by weight based on the total weight of the adhesive.

In a further embodiment, desiccant may be used to improve the moisture barrier properties of the adhesives. The fillers with desiccant properties, referred to as desiccant fillers, suitable for use may be any of those that provide an appropriate moisture scavenging rate, capacity, and residual moisture level (the lowest level of moisture at which the desiccant can actively scavenge water) to meet the allowable moisture level for the specific electronic device. The desiccant fillers will be capable of reacting with, absorbing, or adsorbing water and/or water vapor. A representative list of such desiccants can be found in Dean, J. Lange's Handbook of Chemistry, 1999, McGraw Hill, Inc., New York, NY, pp. 11.5. When a desiccant is used as a moisture scavenger, it may be present at a level of about 0.001% and up to about 0.5% by weight based on the total weight of the adhesive.

The adhesive may also comprise various other additives, such as plasticizers and fillers, all of which are conventionally used in the preparation of PSAs. Any desired combinations of these or other additives may be used in order to adjust the properties such as viscosity and rheology of the resultant adhesive in accordance with the desired final properties.

In a further advantageous development, one or more plasticizers or non-reactive diluents, such as low molecular weight acrylic polymers, phthalates, whale oil plasticizers, mineral oils, or plasticizer resins, are added to the UV curable pressure sensitive adhesive, to adjust the viscosity and rheology of the adhesive before and after cure.

The UV curable pressure sensitive adhesive in the invention is mostly in 100% solid, in either hot melt, warm melt or room temperature liquid form. It has a Brookfield viscosity range of from about 1,000 to about 900,000 cps at the coating temperature, typically in the ranges of about 25 to about 150° C., preferably 1,000 to 90,000 cps from about 25 to about 120° C. Such viscosity range allows the adhesive to be coat-able into films. The film thickness ranges from about 25 to about 250 μm, preferably from about 50 to about 150 μm.

As known by those skilled in the art, the preparation of acrylic polymers can be carried out in solution, emulsion, or bulk polymerization procedures using well-known free radical polymerization techniques. The polymers and the uncured adhesives can then be formed into pure adhesives by removal of the solvent, coagulation of the latex, or melt-processing of the neat polymers.

Polymerization may be conducted in the presence of one or more organic solvents and/or in the presence of water. Suitable organic solvents or mixtures of solvents are alkanes, such as hexane, heptane, octane, isooctane, and cyclohexane; aromatic hydrocarbons, such as benzene, toluene, and xylene; esters, such as ethyl, propyl, butyl and heptyl acetate; halogenated hydrocarbons, such as chlorobenzene; alkanols, such as methanol, ethanol, isopropanol, ethylene glycol, and ethylene glycol monomethyl ether; ethers, such as diethyl ether and dibutyl ether; ketones, such as acetone, methyl ethyl ketone; or mixtures thereof.

In one embodiment of the process, the polymerization reaction proceeds in ethyl acetate solvent in the presence of free radical initiator AIBN.

In another embodiment of the process, the polymerization reaction proceeds in a binary solvent system of ethyl acetate and isopropanol in the presence of free radical initiator AIBN.

The acrylic polymers prepared for the UV curable pressure sensitive adhesive of the invention will generally have an average molecular weight (Mw) of from 1,000 to 3,000,000 g/mol, preferably between 5,000 and 500,000 g/mol. The molecular weight is determined by gel permeation chromatography (GPC) or matrix-assisted laser desorption/ionization mass spectrometry (MALDI-MS).

The UV curable pressure sensitive adhesive can be formulated to be solvent borne or water borne adhesives and be used to make adhesive films and subsequently removing the solvent or water by drying the films. To be used as the UV curable pressure sensitive adhesive of the invention, the acrylic polymers are essentially free of any solvent. Solvent can be removed before or after curing, preferably, in a reaction tank or vacuum mixer. Any solvent being used in making the acrylic polymer and formatting the UV curable adhesive will be removed in a reaction tank or vacuum mixer before coating. However, the UV curable pressure sensitive adhesive can be also formulated to be solvent borne or water borne adhesives and be used to make adhesive films and subsequently removing the solvent or water by drying the adhesive films.

The adhesive composition of the invention is essentially free of any radical reactive functional groups to avoid competition and interference between radical cure and cationic cure during UV irradiation. The radical reactive functional groups, e.g., (meth)acrylic C═C, react with cation radical fragments decomposed from the cationic photoinitiator upon UV irradiation, can hinder the formation of the superacid. Such radical curable components are for example mono- or multi-(meth)acrylate.

Yet another embodiment is directed to an article manufactured using the adhesives of the invention. The adhesive is in film form of a tape, label, coatings. Application of the UV curable pressure sensitive adhesive may be accomplished using any conventional means, such as roller, slot orifice, spray, or extrusion coating. Non-limiting examples of substrate are films, tapes, sheets, panels, foam, and the like; and can be made of materials such as paper, fabric, metal foil, glass, plastic (polyesters, PE, PP, BOPP, and PVC), nonwoven fiber, metal, foil, glass, natural rubber, synthetic rubber, wood, plywood, or cement. If a coated substrate is to be used in the form of a self-wound roll, the back of the substrate is usually coated with a release coating to prevent the adhesive from adhering to the reverse side of the substrate. If a substrate is to be coated with the adhesive on both sides and rolled, a strippable paper or other protective means is laid over the adhesive on one side to prevent that adhesive from adhering to the adhesives on the other. In some uses, a second substrate may be applied directly to the adhesive.

In many articles with pressure sensitive adhesives, the adhesive is applied to a backing or substrate before crosslinking. The adhesive typically formulated to have a sufficient coatable viscosity in temperatures ranges of 25-180° C.

The pure PSAs of this invention have melt viscosity of 1,000-90,000 cPs at lower application temperatures of about 25 to about 120° C. The presence of the reactive diluent reduces the viscosity of the instant UV curable adhesive, and this allows for lower application temperatures ranging from room temperature up to about 120° C. The low application temperatures are particularly preferred for heat sensitive substates, including electronic substrates.

A pressure sensitive adhesive film may be formed by applying the neat adhesive to a release liner, such as silicone coated paper or plastic film, and then after UV light irradiation, the adhesive may be removed from the release liner and used as a free film, to be laminated and transferred to a targeting substrate. The UV curable pressure sensitive adhesive of the invention can be crosslinked in air by irradiation with UV light in the range from 200 to 500 nm, preferably 280 to 400 nm depending on the cationic photoinitiator in the adhesive composition. Irradiation may be done immediately and preferably while the adhesive film is freshly coated. A nitrogen blanket can also be used during the coating and curing process to exclude moisture.

Adhesive composition is irradiated by UV light for a period of time sufficient to transform the low cohesive composition into a viscoelastic adhesive of higher modulus. The exact length of UV exposure or dosage is dependent upon the nature and intensity of the UV light, the amount of cationic photoinitiator, the acrylic polymer and the adhesive compositions, the thickness of the adhesive film, environmental factors such as relative humidity and temperature, and the distance between the radiation source and the adhesive film. The dosage or the length of UV exposure is controlled by the line speed. It may be appropriate to adapt the lamp output to the line speed or to shade off the line belt partly, in order to reduce its thermal load to heat sensitive substrate.

Actinic light from any source may be used on the adhesive, provided the source furnishes an effective amount of UV radiation. Suitable sources of UV light are carbon arcs, mercury-vapor arcs, fluorescent lamps with special ultraviolet light emitting phosphors, electronic flash lamps and the like, lasers of specific wavelengths, UV LED, or combinations of those. Preferred lamps are the electrodeless microwave powered lamps from Fusion Systems, or commercially customary high or medium pressure mercury lamps with an output of, for example, from 80 to 240 W/cm. A particularly preferred UV light is high intensity LED with a wavelength of 365 nm, 385 nm, 395 nm, 405 nm, or a combination thereof. The adhesive compositions of the invention generally exhibit their maximum sensitivity to wavelengths in the ultraviolet range of 280 to 400 nm.

The adhesives of the present invention may be used to bond a first substrate to a second substrate. Substrates include but are not limited to paper, plastic, glass or plastic-coated glass, wood, cement, metal, foil, and the like. The adhesive may be applied by a variety of methods including coating or spraying in an amount sufficient to cause the substrates to be bonded together to adhere. The adhesive coated substrate may be irradiated before or after bonding. Since crosslinking reaction begins immediately upon UV irradiation, but may not be completed for several days, there is time immediately after irradiation, but before gelation for bonding to take place. Occasionally, the bond is made before UV irradiation for optimum wet out and adhesion.

The pressure sensitive adhesives of the invention may advantageously be used in the manufacture of adhesive articles including, but not limited to, industrial tapes and transfer films. Single and double face tapes, as well as supported and unsupported free films are encompassed by the invention. In one embodiment, the adhesive article comprises an adhesive coated on at least one major surface of a backing having a first and second major surface. Useful backing substrates include, but are not limited to foam, metal, paper, fabric, and various polymers such as polypropylene, polyamide, polyester, polyethylene terephthalate, and mixtures thereof. The adhesive may be present on one or both surfaces of the backing. When the adhesive is coated on both surfaces of the backing, the adhesive coatings can be the same or different.

The following examples are provided to describe the invention in further detail. These examples, which set forth a preferred mode presently contemplated for carrying out the invention, are intended to illustrate and not to limit the invention.

### EXAMPLES

Adhesives and their properties were tested according to the following test procedure or method as described below.

Viscosity: Brookfield DV-I Viscometer was used to measure viscosity. For testing, 11 g sample was used with a spindle No 27 at a speed setting from 1 to 4 rpm at a temperature from 25 to 120° C.

Preparation of adhesive coatings: A bench top Chemsultants® hot melt laminator coater was used to make the adhesive coatings. The adhesive was heated to 100 to 135° C. and coated onto a 2 mil (51 μm) thick silicone-coated PET release liner. The adhesive on the PET liner was irradiated at certain line speeds to reach the necessary UV dosage. The UV light sources were either H-bulb (Fusion Systems) or Heraeus 365 nm LED lamp. The film was then laminated and transferred to a polyethylene terephthalate substrate (Mylar®, DuPont) and conditioned at 23° C. and 50% relative humidity.

UV Dosage: The UV dosage was measured and recorded using an EIT Power Puck II.

Shear Adhesion: Sear adhesion was measured according to Procedure A, PSTC-107, adapted as follows. All test samples of the acrylic polymers were UV irradiated according to the procedure described above. The shear adhesion was measured under a shear load of 1 kg on a ½″×1″ area, applied after wetting out the test panel for 15 min. All testing was performed at 23° C. and 50% relative humidity. The time to failure was recorded.

Loop Tack: Loop tack was measured according to Test Method B, PSTC-16, adapted as follows. A loop tack tester was used for the measurement. All test samples of the acrylic polymers were UV-irradiated according to the procedure described above. The adhesive was coated on 2 mil PET film backing and the size of a specimen strip was 6″×1″.

Peel Adhesion: Peel adhesion at 180° between the substrate and the adherend test was measured according to Test method A, PSTC-101, adapted as follows. All test samples of the acrylic polymers were UV-irradiated according to the procedure described above. The peel strength was measured after wetting out a stainless-steel panel for 15 min.

Shear Adhesion Failure Temperature (SAFT): Three samples, 1″×3″ in dimensions, were cut from each cured sample in the machine coating direction. SAFT panels (mirrored steel) were cleaned with ethyl acetate. Samples were adhered to the steel panel overlapping up to an engraved line so that a square 1″×1″ of adhesive was in contact with the test panel. The test area was rubbed using a straight edged wooden applicator to ensure good contact between the panel and test sample.

Samples were placed into the test oven at room temperature. The heating program was started, and 1 kg shear load applied when the temperature reached 40° C. The oven temperature was ramped at 0.5° C./minute up to 200° C. and the failure temperature (SAFT) was recorded.

### Example 1

A four-neck 1 L round-bottom polymerization flask was equipped with a thermometer connected to a temperature control device, a condenser, an overhead mechanical stirrer, two addition funnels, and nitrogen inlet/outlet. The set-up was purged with nitrogen gas for 15 min. A mixture of the following monomers was prepared: 2-ethyihexylacrylate (78.0 g), methyl acrylate (71.6 g), 1-acrylomethyl-3,4-cyclohexene epoxide (0.5 g). To one of the funnels was charged 100 g of the monomer mixture. To another funnel was charged the initiator 2,2′-azobis-(2-methyl propionitrile) (AIBN, 0.6 g) and ethyl acetate (40 mL). To the polymerization flask was charged the remaining monomer mix (50 g), initiator AIBN (0.2 g), and ethyl acetate (80 mL). The mixture was heated to vigorous reflux and held for 15 min. Then, the monomer mix in the funnel was added continuously over 2 hours at a constant rate. Simultaneously, the initiator solution in the funnel was added continuously over 3 hours at a constant rate. Upon complete addition of initiator solution, the mixture was stirred for an additional 2 hours at reflux. A short half-life initiator (0.75 g) and ethyl acetate (20 mL) were charged into the initiator funnel and then added into the polymerization flask over 1 hour to reduce residual monomers. An acrylic polymer was obtained with weight average molecular weight Mw of 277,000 g/mol and PDI of 6.1 by GPC. The polymerization solution was cooled to 60° C. TECKROS R86 tackifier (21.4 g) and cationic photoinitiator OMNICAT 320 (1.0 g) were added and mixed thoroughly for 15 min. After ethyl acetate was removed by under vacuum at 60° C., a UV curable pressure sensitive adhesive was obtained having a viscosity (Brookfield) of 100,000 cps at 135° C. Its viscosity increased 20% in 24 h at 135° C. Therefore, it had high viscosity for film coating and was not thermal stable at 135° C. or above.

### Example 2

The UV curable pressure sensitive adhesive of Example 1 was formulated by adding reactive diluent epoxidized soybean oil NATUREFLEXX ESO. The resulting PSA properties were shown in Table 1. The obtained adhesives were coated onto 2 mil PET film at lower temperature of 110-120° C. into 2 mil thickness and cured with UVC dosage of 60 mJ/cm² by Fusion H bulb. PSA property tested on stainless steel panels according to PSTC methods for peel, loop tack, shear, and SAFT. With the addition of the epoxidized soybean oil, the UV curable pressure sensitive showed much lower and coatable viscosity and its viscosity changes over time at lower temperature were less and thus more thermally stable for the hotmelt coating process. Furthermore, the overall PSA properties were also improved with the addition of the epoxidized soybean oil, especially the cohesive strength and high temperature adhesion strength.

TABLE 1
Different reactive diluent amount and PSA properties

| | | | | | | Shear | SAFT |
|---|---|---|---|---|---|---|---|
| Example | | | Viscosity | | Loop | 4.4 | 2.2 |
| 1 Polymer | ESO, | Viscosity | increases | Peel | Tack | psi, | psi, |
| wt % | wt % | cps | in 24 hr | lb/in | lb/in | hours | ° C. |
| 100 | 0 | 100,000 | 20% at | 6.1 | 3.9 | 86 | 104 |
| | | at 135° C. | 135° C. | | | | |
| 85 | 15 | 58,500 | 2% in | 5.3 | 4.1 | >168 | >200 |
| | | at 120° C. | 120° C. | | | | |
| 75 | 25 | 63,000 | 0.5% in | 4.8 | 4.0 | >168 | >200 |
| | | at 110° C. | 110° C. | | | | |

### Example 3

A four-neck 1 L round-bottom polymerization flask was equipped with a thermometer connected to a temperature control device, a condenser, an overhead mechanical stirrer, two addition funnels, and nitrogen inlet/outlet. The set-up was purged with nitrogen gas for 15 min. A mixture of the following monomers was prepared: butyl acrylate (148.8 g), and 1-acrylomethyl-3,4-cyclohexene epoxide (1.2 g). To one of the funnels was charged 112 g of the monomer mixture. To another funnel was charged the initiator 2,2′-azobis-(2-methyl propionitrile)(AIBN, 0.1 g), isopropanol (15 g) and ethyl acetate (45 mL). To the polymerization flask was charged the remaining monomer mix (38 g), initiator AIBN (0.2 g), isopropanol (6 mL), ethyl acetate (34 mL). The mixture was heated to vigorous reflux and held for 15 min. Then, the monomer mix in the funnel was added continuously for 2 hours at a constant rate. Simultaneously, the initiator solution in the funnel was added continuously over 3 hours at a constant rate. Upon complete addition of initiator solution, the mixture was stirred for an additional 2 hours at reflux. A short half-life initiator (0.75 g) and ethyl acetate (25 mL) were charged into the initiator funnel and then added into the polymerization flask over 1 hour to reduce residual monomers. After ethyl acetate was removed by vacuum at 55-60° C., acrylic adhesive II was obtained with a weight average molecular weight Mw of 58,000 g/mol and PDI of 2.6 by GPC and viscosity of 130,000 cps at 60° C. by Brookfield.

### Example 4

The PSA properties of the formulated adhesives prepared by mixing the acrylic polymer from Example 3 with the reactive diluent NATUREFLEXX ESO, tackifier R86 and cationic photoinitiator OMNICAT 320 were shown in Table 2. All adhesive films were 1 mil thickness, coated directly on 2 mil PET, cured with 40 mJ/cm² UVC by Fusion H bulb, and tested on stainless steel panels for peel, loop tack, and shear. Without the addition of epoxidized soybean oil, the adhesive film had no cohesive strength, and the shear was less than 0.1 hours at 4.4 psi. Addition of epoxidized soybean oil led to high shear strength and lower peel and tack. The addition of the ESO diluent reduced the viscosity of the adhesive to 50,000 to 80,000 cps at 30° C., and this allowed for the UV-curable adhesive films to be coatable at room temperature.

TABLE 2
Different reactive diluent amount and PSA properties

| Example 3 | | | | | | Shear |
|---|---|---|---|---|---|---|
| Polymer | ESO, | R86, | OMNICAT | Peel | Loop Tack | 4.4 psi, |
| wt % | wt % | wt % | 320, g | lb/in | lb/in | hours |
| 100 | 0 | 0 | 0.5 | | | <0.1 |
| 50 | 15 | 35 | 0.5 | 4.5 | 3.4 | 6 |
| 50 | 20 | 30 | 0.5 | 3.1 | 2.2 | 11 |

### Example 5

With a proper cationic photoinitiator, the UV-curable adhesives can also be cured by LED 365 nm lamp, as shown in Table 3. All adhesive films were 1 mil thickness, coated directly on 2 mil PET, cured with LED 365 nm with a dosage of 600 mJ/cm², and tested on stainless steel panels for Shear. OMNICAT 320 alone was insufficiently reactive under LED 365 nm. Combining OMNICAT 320 with ITX as photosensitizer improved cohesive strength of the adhesive as demonstrated with higher shear strength in Table 3. Adhesive with photoinitiator NSC-121 (made in accordance with U.S. Pat. No. 7,230,122) demonstrated highest cohesive strength with shear at 4.4 psi value as 27 hours. In addition, adhesive made with NSC-121 also had better compatibility with the acrylic polymer from Example 3, and the resultant adhesive films were all clear and transparent, while the films with OMNICAT 320 were hazy. Furthermore, NSC-121 was thermally stable below 60° C. The addition of reactive diluent ESO made it possible to decrease the adhesive coating temperature to below 60° C., despite the acrylic polymer obtained from Example 3 having a viscosity of about 130,000 cps at 60° C.

TABLE 3
LED vs Fusion and PSA properties

| Example 3 | | | | Shear |
|---|---|---|---|---|
| Polymer wt % | ESO | R86 | Photoinitiator | 4.4 psi |
| 65 g | 25 g | 10 g | 0.5 g of Omnicat 320 | 1.2 hours |
| 65 g | 25 g | 10 g | 0.5 g of ITX, 0.5 of | 3.4 hours |
| | | | Omnicat 320 | |
| 65 g | 25 g | 10 g | 0.5 g of NSC-121 | 27 hours |

1. An ultra-violet curable pressure sensitive adhesive comprising:
A. 10-95% wt of an acrylic polymer having at least one terminal or pendant reactive functional group selected from the group consisting of cycloaliphatic epoxide, vinyl ether, oxirane, oxetane, and mixtures thereof;
B. 4-90% wt of a reactive diluent, which is essentially free of mono- or multi-(meth)acrylate; and
C. 0.01 to 5 wt % of a cationic photoinitiator;
wherein the total weight of the ultra-violet curable pressure sensitive adhesive is 100 wt %.

2. The ultra-violet curable pressure sensitive adhesive of claim 1, wherein the acrylic polymer is prepared from:
(i) a first monomer having a reactive functional group selected from cycloaliphatic epoxide, vinyl ether, oxirane, oxetane or mixtures thereof; and
(ii) an acrylic monomer consisting of an acrylic or methacrylic acid derivative of the formula CH₂═CH(R₁)(COOR₂), wherein R₁ is H or CH₃ and R₂ is C₁₋₂₄ alkyl chain;
wherein the (i) first monomer is present from about 0.001 to about 10 g per 100 g of the (ii) acrylic polymer.

3. The ultra-violet curable pressure sensitive adhesive of claim 2, wherein the acrylic polymer has (a) a Tg value less than 0° C. and (b) a weight average molecular weight (Mw) from about 1,000 to about 1,000,000 g/mol.

4. The ultra-violet curable pressure sensitive adhesive of claim 2, wherein the (i) first monomer is a cycloaliphatic epoxide having the formula: 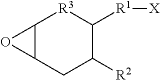
wherein
R¹ is O, S, CO, or linear, branched, or cyclic alkylene, or oxyalkylene, arylene,
R² is linear, branched, and cyclic alkyl or alkoxy, aryl, H, halogen, C═O, or part of R¹ as fused cycloaliphatic ring through a covalent bond connection,
R³ is (CH₂)ₙ, n=0-3,
X is acrylate or methacrylate, or comprises a —W—Y group,
W is O, S, amide, carbonate, urethane, urea, siloxane, or a combination thereof, and
Y is —R⁴—C(R⁵)═CH₂, where R⁴ is a linear or branched C₂₋₁₀ alkylene, C₂₋₁₀oxyalkylene, C═O, or arylene or derivative thereof, and R⁵ is H or CH₃.

5. The ultra-violet curable pressure sensitive adhesive of claim 4, wherein the cycloaliphatic epoxide has the formula:

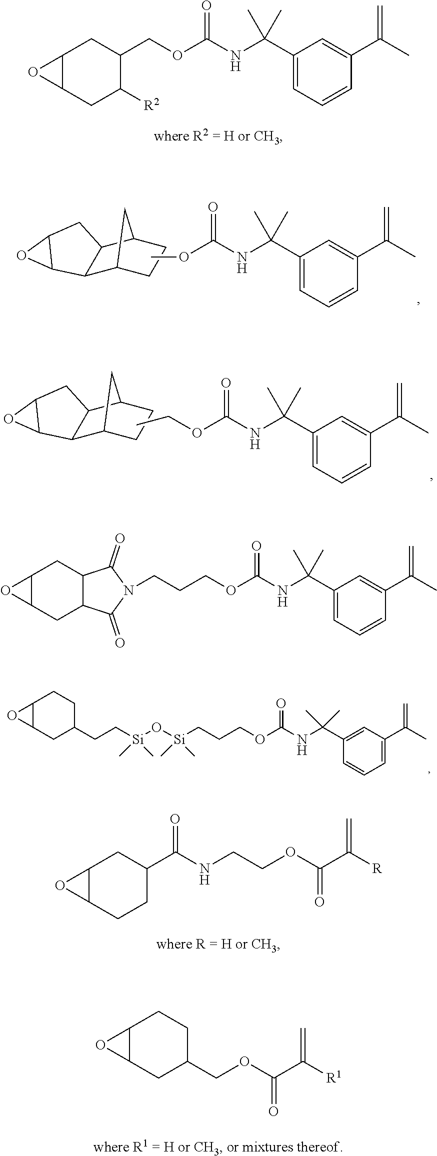

6. The ultra-violet curable pressure sensitive adhesive of claim 1, wherein the reactive diluent is a polymer, oligomer or macromer comprising at least one terminal or pendant reactive functional group selected from cycloaliphatic epoxide, oxirane, oxetane, vinyl ether, or mixtures thereof.

7. The ultra-violet curable pressure sensitive adhesive of claim 6, wherein the reactive diluent has a weight average molecular weight from about 100 to about 500,000 g/mol.

8. The ultra-violet curable pressure sensitive adhesive of claim 7, wherein the reactive diluent is an epoxy functionalized soybean oil, epoxy functionalized polybutadiene, epoxy-functional polyurethane, epoxy functionalized polysiloxane, epoxy functionalized polyisobutylene, epoxy-difunctionalized bisphenol A epoxy resin, epoxy-difunctionalized bisphenol F epoxy resin, epoxy functionalized polyacrylate, epoxy functionalized polyethylene glycol, epoxy functionalized polypropylene glycol, epoxy functionalized polyether, or mixtures thereof.

9. The ultra-violet curable pressure sensitive adhesive of claim 8, wherein the reactive diluent is an epoxy functionalized soybean oil, epoxy functionalized polybutadiene, epoxy-difunctionalized bisphenol A epoxy resin, epoxy-difunctionalized bisphenol F epoxy resin, or mixtures thereof.

10. The ultra-violet curable pressure sensitive adhesive of claim 1, wherein the cationic photoinitiator is a sulfonium salt or iodonium salt.

11. The ultra-violet curable pressure sensitive adhesive of claim 10, wherein the cationic photoinitiator has the structure of

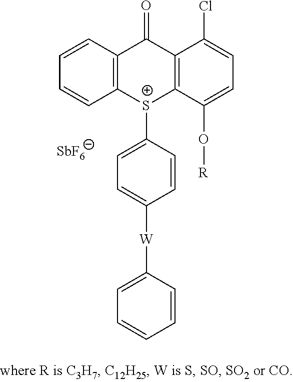

12. The ultra-violet curable pressure sensitive adhesive of claim 11 wherein the cationic photoinitiator is:

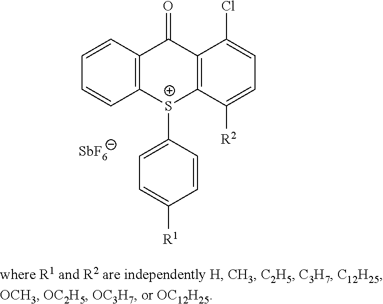

13. The ultra-violet curable pressure sensitive adhesive of claim 1, wherein the cationic photoinitiator is mixed with a radical photosensitizer selected from thioxanthen-9-one, 2-Isopropylthioxanthone, 2-chlorothioxanthen-9-one, 2,4-Diethyl-thioxanthen-9-one or 1-chloro-4-propoxythioxanthone.

14. The ultra-violet curable pressure sensitive adhesive of claim 1, further comprising a tackifier, a thermal stabilizer or a moisture scavenger.

15. The ultra-violet curable pressure sensitive adhesive of claim 1, wherein the adhesive is essentially free of an organic solvent.

16. An ultra-violet curable pressure sensitive adhesive having a matrix comprising:
(A) an acrylic polymer bound to its backbone with reactive functional groups selected from cycloaliphatic epoxide, oxirane, oxetane, vinyl ether, or mixtures thereof;
(B) a reactive diluent having a terminal or pendant functional group selected from cycloaliphatic epoxide, oxirane, oxetane, vinyl ether, or mixtures thereof; and
(C) a cationic photoinitiator, wherein the matrix is essentially free of mono- or multi-(meth)acrylate groups.

17. An article of manufacture comprising the ultra-violet curable pressure sensitive adhesive of claim 1.

18. The article of claim 17 which is a tape, coating, or label.

19. The article of claim 18 further comprising a backing selected from the group consisting of polyester, polypropylene, polyethylene, paper, fabric, polycarbonate, metal, and glass.

20. A cured ultra-violet curable pressure sensitive adhesive of claim 1.
